(19) United States
(12) Patent Application Publication
(10) Pub. No.: US 2019/0060847 A1
(43) Pub. Date: Feb. 28, 2019

(54) DECANT DEVICE

(71) Applicant: Chang Hsien LIU, Taoyuan City (TW)

(72) Inventor: Chang Hsien LIU, Taoyuan City (TW)

(21) Appl. No.: 15/690,989

(22) Filed: Aug. 30, 2017

(51) Int. Cl. B01F 3/04

(52) U.S. Cl. CPC B01F 3/04787; B01F 2215/0072; B01F 2003/04872

(57) ABSTRACT

A decant device includes a tubular body being hollowed and having an upper end and a lower end being open. The lower end is capable of combining with a mouth of a cup. A dispenser is assembled in the tubular body. The dispenser has a plate body laterally connected to an inner wall of the tubular body. The plate body has a center portion and the plate body has a curved surface protruding from the center portion toward the lower end. The plate body has a plurality of through holes surrounding the center portion, and an extension direction of each of the through holes is perpendicular to a corresponding portion of the curved surface where the through hole is located.

### BACKGROUND OF THE INVENTION

### Field of the Invention

The present invention relates to a wineware, in particular to a decant device.

### Description of the Prior Art

Once a decant procedure is applied to a wine (especially grape wine) before drinking, the aroma of the wine can be promoted and the acerbic taste of the wine can be softened, so that the taste of the wine would be much mellower. The principle for decanting wine is allowing the wine to contact air to oxidize the wine by a proper extent. Currently, market available decant devices are designed according to the aforementioned principle.

A conventional decant device is illustrated in FIG. 10. The decant device has a tubular body 4, a T-shaped channel is assembled in the tubular body 4, and the T-shaped channel is formed by a cone-shaped wine channel 41 and an air channel 42. In operation, the tubular body 4 is inserted into the bottle mouth 5 of a wine bottle, so that the wine channel 41 is in communication with the wine bottle. Hence, when the wine in the wine bottle is poured to a wine vessel via the decant device, the wine is flowing through the wine channel 41 and ambient airs are suctioned into the air channel 42 by the Venturi effect, so that the airs are mixed with the wine in the wine channel 41, thus, the wine can be decanted.

Because the shape of the wine bottle would greatly influence the texture of the bottle, the shape of the wine bottle is various, and the size of the bottle mouth 5 is not uniform. However, the conventional decant device is just suitable for a wine bottle in which the size of the bottle mouth 5 is corresponding to the tubular body 4; otherwise, the conventional decant device cannot be positioned on the wine bottle. As a result, the conventional decant device cannot be widely utilized.

Therefore, how to solve the problem is an issue.

### SUMMARY OF THE INVENTION

One object of the present invention is to provide a decant device which is assembled on a drinking vessel. The decant device can be widely used for carrying on wines from wine bottles with different shapes and for decanting the wines. Furthermore, the through holes of the decant device are projecting downwardly, so that the wines in the decant device can be in contact with the ambient air with a greater surface area and in a longer time, thereby improving the decanting effect.

In view of these objects, the present invention provides a decant device comprising:

a tubular body being hollowed and having an upper end and a lower end being open, wherein the lower end is capable of combining with a mouth of a cup;

a dispenser assembled in the tubular body, wherein the dispenser has a plate body laterally connected to an inner wall of the tubular body, the plate body has a center portion, the plate body has a curved surface protruding from the center portion toward the lower end; the plate body has a plurality of through holes surrounding the center portion, an extension direction of each of the through holes is perpendicular to a corresponding portion of the curved surface where the through hole is located.

In one embodiment, a bore size of the upper end gradually increases from bottom to top, and the lower end has a threading portion.

In one embodiment, each of the through holes is a round hole.

In one embodiment, the through holes comprise round holes and curved oblong holes, and the curved oblong holes are located at an outer side of the round holes.

In one embodiment, each of the through holes is a fan-shaped hole, and two sides of each of the through holes form inclined surfaces.

The purposes and the advantages of the present invention can be understood from the embodiments and the drawings.

### BRIEF DESCRIPTION OF THE DRAWINGS

FIG. 1 illustrates a perspective view of a decant device according to a first embodiment of the present invention;

FIG. 2 illustrates a top view of the decant device of the first embodiment;

FIG. 3 illustrates a sectional view of the decant device of the first embodiment;

FIG. 4 illustrates an operational view of the decant device of the first embodiment;

FIG. 5 illustrates a perspective view of a decant device according to a second embodiment of the present invention;

FIG. 6 illustrates a top view of the decant device of the second embodiment;

FIG. 7 illustrates a perspective view of a decant device according to a third embodiment of the present invention;

FIG. 8 illustrates a top view of the decant device of the third embodiment;

FIG. 9 illustrates a cross-sectional view along line A-A shown in FIG. 8; and

FIG. 10 illustrates an operational view of a conventional decant device.

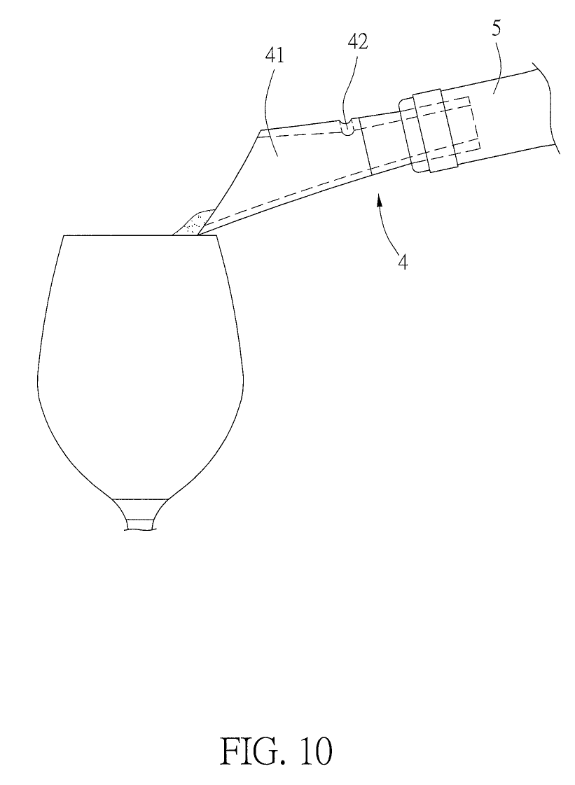

### DETAIL DESCRIPTION OF THE PREFERRED EMBODIMENTS

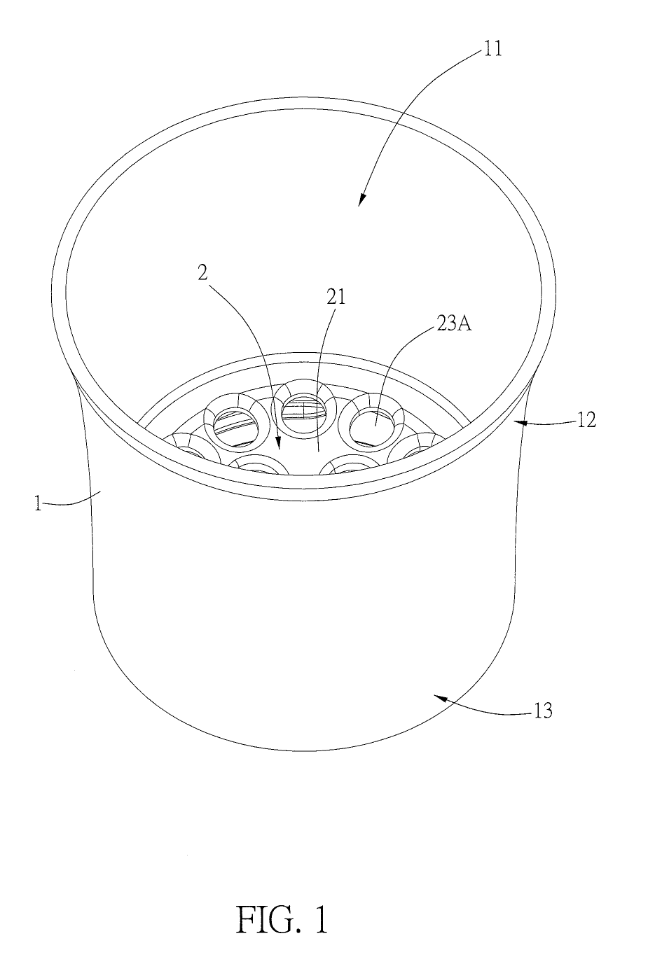

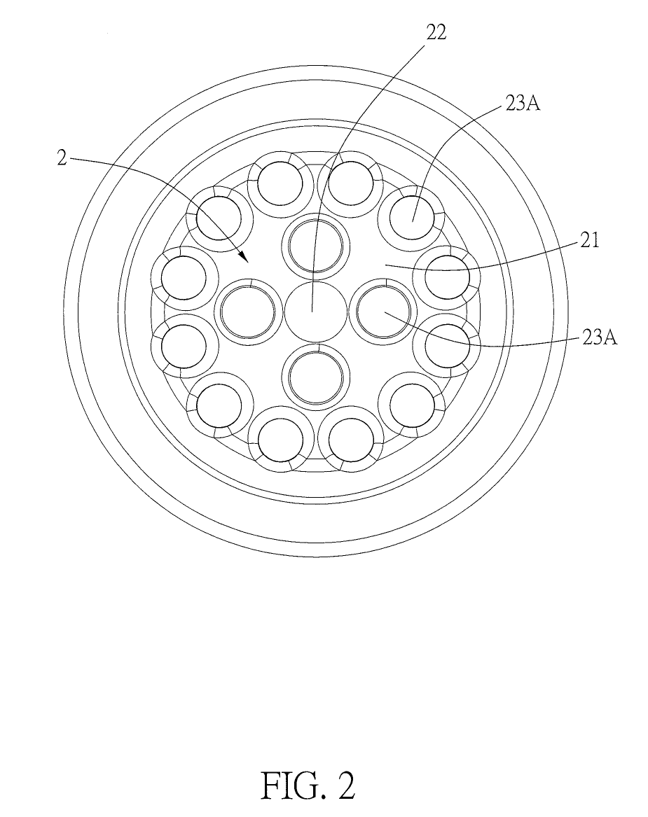

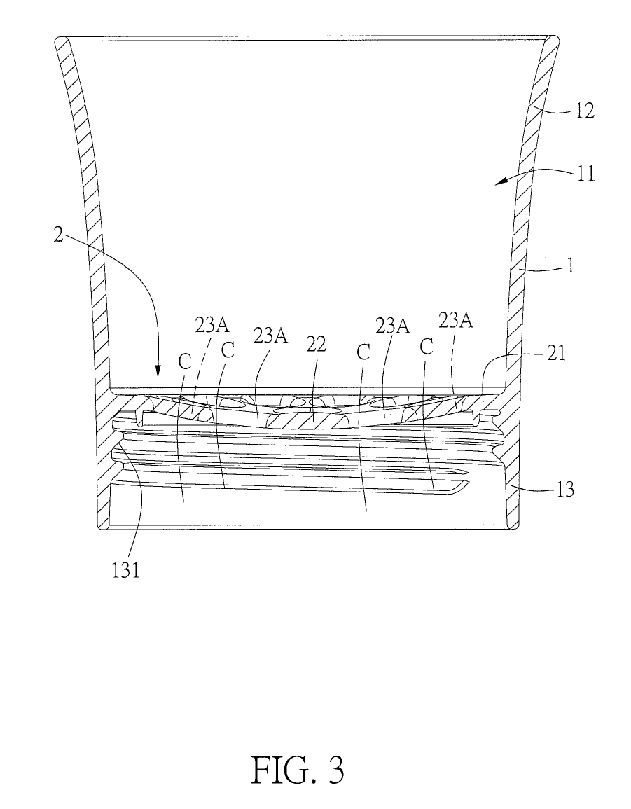

Please refer to FIGS. 1 to 3, illustrating a decant device according to a first embodiment of the present invention. The decant device comprises a hollowed tubular body 1 enclosing a flow channel 11. An upper end 12 and a lower end 13 of the tubular body 1 are open. The bore size of the upper end 12 increases gradually from bottom to top. The lower end 13 is used to be combined with a mouth of a cup. In this embodiment, the lower end 13 has threading portion 131, and the threading portion 131 is used to combine with the corresponding threading portion of the mouth of the cup.

Moreover, a dispenser 2 is assembled in the tubular body 1. The dispenser 2 is laterally connected to an inner wall of the tubular body 1 and laterally located across the flow channel 11. The dispenser 2 has a plate body 21, and a periphery of the plate body 21 is connected to the inner wall of the tubular body 1. The plate body 21 has a center portion 22, and the plate body 21 has a curved surface protruding from the center portion 22 toward the lower end 13. Accordingly, the height of the center portion 22 of the plate body 21 is lower than the height of the periphery of the plate body 21.

Furthermore, the plate body 21 has a plurality of through holes 23A. The through holes 23A surround the center portion 22 and the through holes 23A are aligned in a symmetrical manner. In this embodiment, the through holes 23A are round holes. Additionally, each of the through holes 23A has a center axis C for representing the extension direction of the through hole 23A. The center axis C of each of the through holes 23A is perpendicular to the corresponding portion of the curved surface where the through hole 23A is located. Accordingly, from a perspective view of the plate body 21, each of the through holes 23A projects toward the lower end 13 of the tubular body 1.

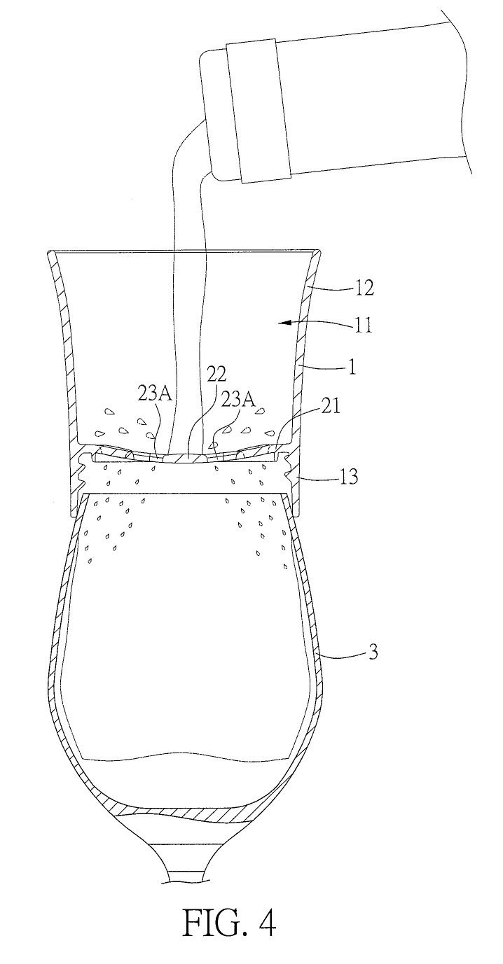

Accordingly, in operation, as shown in FIG. 4, the lower end 13 of the tubular body 1 is fitted over or threaded with the mouth of a cup 3, so that the flow channel 11 is connected to the cup 3. When the wine is poured into the tubular body 1, the wine impacts the center portion 22 of the plate body 21 and splashes outwardly, and then the wine is flowing downward along the inner wall of the tubular body 1. Therefore, after the wine is fell on the plate body 21, the wine is collected at the center portion 22 because of the shape of the plate body 21, and the wine passes through the through holes 23A and falls in the cup 3. Hence, due to the profiles of the through holes 23A, the wine can be spread everywhere and poured into the cup 3. Thus, when the wine is pouring into the cup 3, the wine can be in contact with and mixed with the air, thereby achieving the decanting effect. Specifically, this embodiment is suitable for champagnes.

The advantage of the present invention is that the decant device is assembled on the cup, so that the decant device can be used with wine bottles with different sizes. Accordingly, the decant device can be widely used and can be used conveniently.

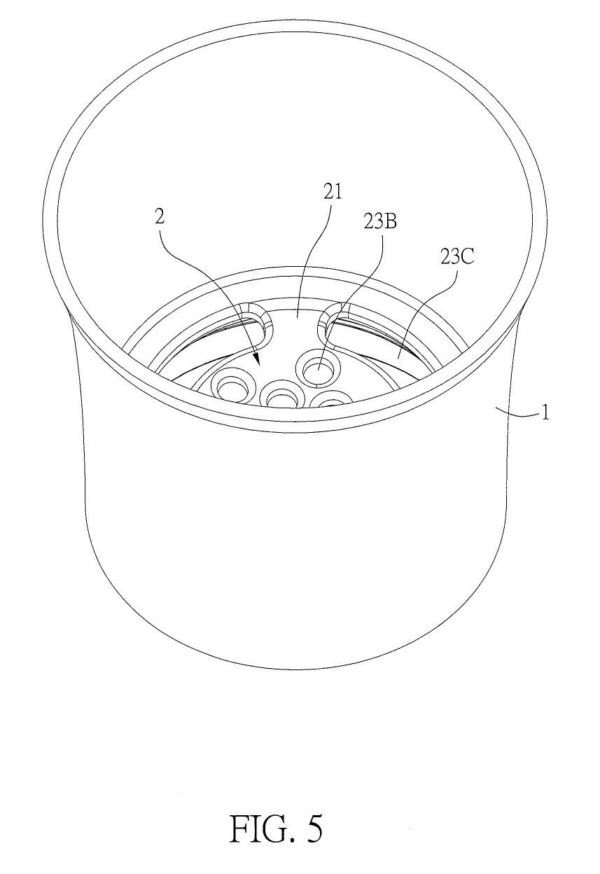

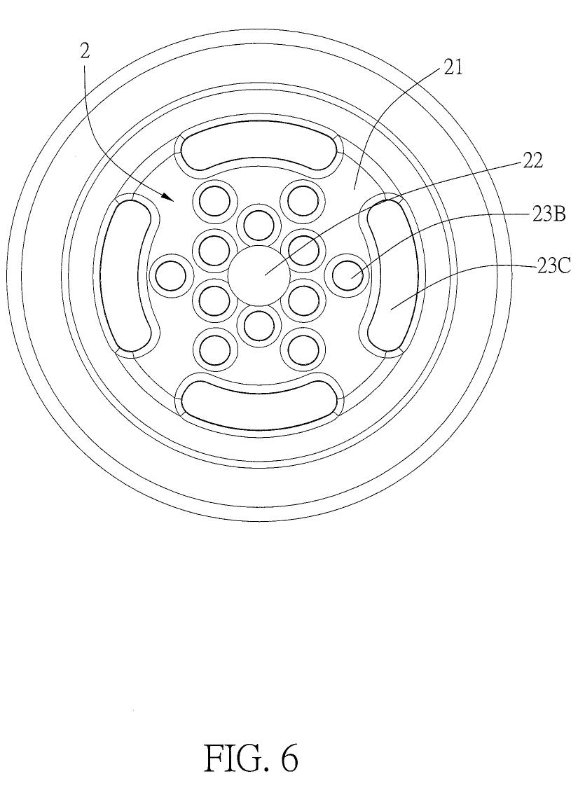

Please refer to FIGS. 5 and 6, illustrating a decant device according to a second embodiment of the present invention. In this embodiment, the shape of the through hole is different. In this embodiment, the plate body 21 has through holes comprising round holes 23B and curved oblong holes 23C, and the curved oblong holes 23C are located at an outer side of the round holes 23B. According to the shape of the through holes, the decant device of this embodiment is suitable for fruit wines.

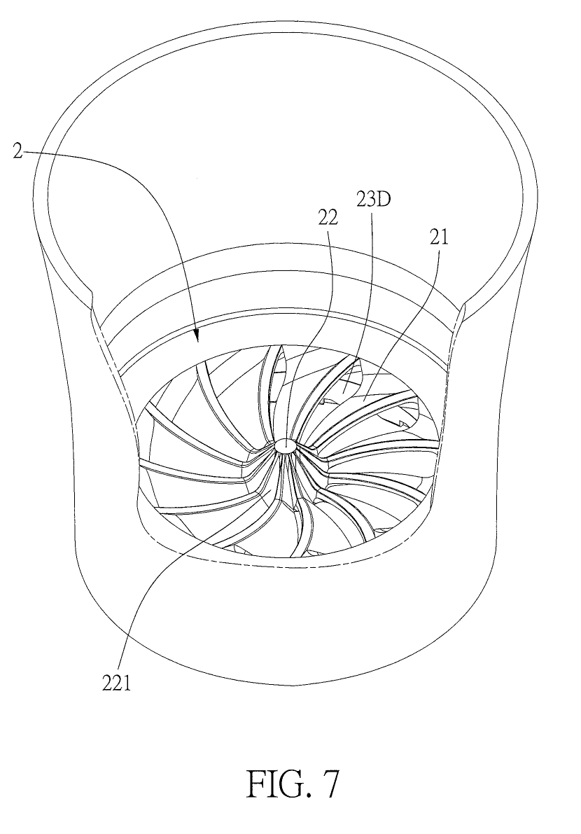

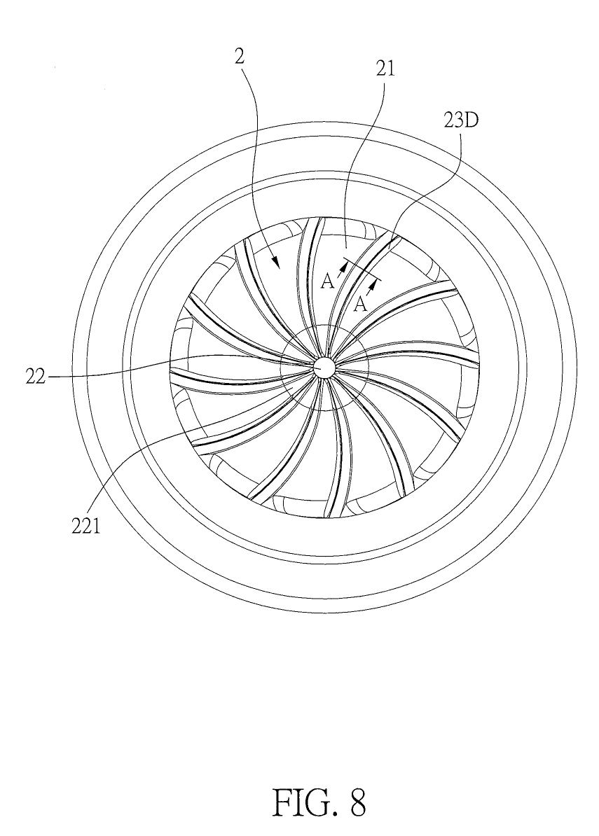

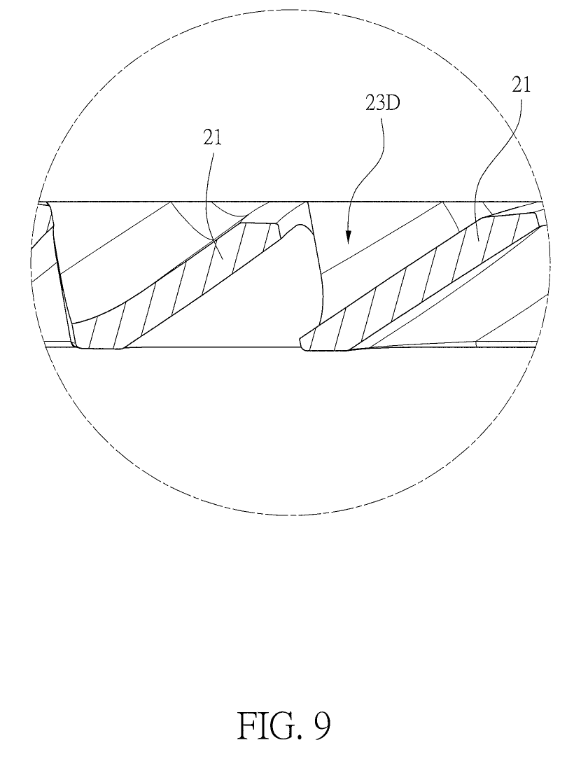

Please refer to FIGS. 7 and 8, illustrating a decant device according to a third embodiment of the present invention. In this embodiment, the shape of the through hole is different. In this embodiment, the plate body 21 has through holes being fan-shaped through holes 23D. Further, as shown in FIG. 9, two sides of each of the fan-shaped through holes 23D form inclined surfaces. According to the shape of the through holes, the decant device of this embodiment is suitable for grape wines. Moreover, in this embodiment, the center portion 22 is protruding upwardly, and a plurality of grooves 221 is extending from the center portion around the center portion 22. Therefore, when the red wine is pouring to the center portion 22, the red wine can be spread everywhere and flowing to the fan-shaped through holes 23D along the grooves 221, thereby achieving the decanting effect.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A decant device, comprising:
a tubular body being hollowed and having an upper end and a lower end being open, wherein the lower end is capable of combining a mouth of a cup;
a dispenser assembled in the tubular body, wherein the dispenser has a plate body laterally connected to an inner wall of the tubular body, the plate body has a center portion, the plate body has a curved surface protruding from the center portion toward the lower end; the plate body has a plurality of through holes surrounding the center portion, an extension direction of each of the through holes is perpendicular to a corresponding portion of the curved surface where the through hole is located.

2. The decant device according to claim 1, wherein a bore size of the upper end gradually increases from bottom to top.

3. The decant device according to claim 1, wherein the lower end has a threading portion.

4. The decant device according to claim 1, wherein each of the through holes is a round hole.

5. The decant device according to claim 1, wherein the through holes comprise round holes and curved oblong holes, and the curved oblong holes are located at an outer side of the round holes.

6. The decant device according to claim 1, wherein each of the through holes is a fan-shaped hole.

7. The decant device according to claim 6, wherein two sides of each of the through holes form inclined surfaces.
